(19) United States
(12) Patent Application Publication
(10) Pub. No.: US 2019/0335702 A1
(43) Pub. Date: Nov. 7, 2019

(54) UNIVERSAL DYNAMIC HINGE FOR A FOLDABLE APPARATUS

(71) Applicant: KIDS II, INC., Atlanta, GA (US)

(72) Inventors: David THRIFT, Alpharetta, GA (US); Bradford Joseph ROGERS, Decatur, GA (US); Keena HOLLEY, Atlanta, GA (US); ErJui WANG, Guangdong (CN); Franco LODATO, Atlanta, GA (US); Andy LOGAN, Atlanta, GA (US)

(73) Assignee: KIDS II, INC., Atlanta, GA (US)

(21) Appl. No.: 16/401,549

(22) Filed: May 2, 2019

Related U.S. Application Data
(60) Provisional application No. 62/665,842, filed on May 2, 2018.

(51) Int. Cl. A01K 1/00; A47D 13/06; A47D 9/00; E04H 15/48; A45B 25/10; F16C 11/04

(52) U.S. Cl. CPC A01K 1/0035; A47D 13/063; F16C 11/04; E04H 15/48; A45B 25/10; A47D 9/005

(57) ABSTRACT

A dynamic hinge mechanism that connects frame elements of a foldable apparatus such as for example a children's play-yard or other folding containment or structure, including an elastic element that applies a biasing force to assist in erecting the apparatus from a folded configuration to an expanded configuration.

### CROSS-REFERENCE TO RELATED APPLICATION

This application claims the benefit of U.S. Provisional Patent Application Ser. No. 62/665,842 filed May 2, 2018, the entirety of which is hereby incorporated herein by reference for all purposes.

### TECHNICAL FIELD

The present disclosure relates generally to the field of dynamic structural devices, and in example forms to accessories and support devices that require setup and/or assembly such as for children, infants, adults, and animals. The present disclosure also relates to foldable devices and accessories, for example children's accessories, which incorporate folding and self-erecting structures having dynamic hinge elements.

### SUMMARY

In example embodiments, the present disclosure relates to a dynamic hinge or joint that is adaptable for use with a variety of devices, structures, systems and/or methods. For example, a folding and self-erecting structural frame including one or more dynamic hinges may be incorporated into a children's play-yard, a bassinet, a pet home, a container, an umbrella, or various other apparatus. In example forms, two or more structural elements such as frame members are coupled by a hinge or pivot joint incorporating one or more elastic elements that bias the structural elements from a first configuration toward a different second configuration. For example, dynamic hinges of a folding play-yard may bias the frame of the play-yard from a compact folded configuration for storage and transport toward an upright expanded configuration for use, to provide a structure that is wholly or partially self-erecting, allowing a parent or adult caregiver to more easily set up the play-yard.

In one aspect, the disclosure relates to a children's play-yard apparatus. The play-yard apparatus preferably includes a support frame having a plurality of frame elements, at least a portion of the plurality of frame elements being pivotally coupled to one another to enable folding of the support frame from an expanded configuration to a folded configuration. The play-yard apparatus preferably also includes a flexible cover material supported by the support frame, the cover material being configured to move with the support frame as it folds from the expanded configuration to the folded configuration. The play-yard apparatus preferably also includes at least one dynamic hinge coupled between at least two of the plurality of frame elements, the dynamic hinge allowing pivotal movement between the at least two frame elements, and biasing the support frame from the folded configuration toward the expanded configuration.

In another aspect, the disclosure relates to a dynamic hinge assembly for pivotally coupling a first frame element and a second frame element of an apparatus. The dynamic hinge assembly preferably includes at least one elastic member having a first portion attached to the first frame element, a second portion attached to the second frame element, and an intermediate portion retained in tension between the first and second portions to bias the first and second frame elements from a first configuration to a different second configuration.

In still another aspect, the disclosure relates to a folding apparatus including a structural support frame having a first frame element, a second frame element, a third frame element, and a fourth frame element. The frame is preferably reconfigurable between an expanded configuration and a compact configuration. The folding apparatus preferably also includes a dynamic hinge pivotally coupling at least the first frame element and the second frame element. The dynamic hinge preferably includes at least one elastic element engaged in tension between the first frame element and the second frame element when the frame is in its compact configuration. In this manner, the elastic element at least partially assists in erecting the frame from the compact configuration to the expanded configuration.

Various aspects, features and advantages of the disclosure will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a children's play-yard apparatus incorporating dynamic hinges, according to an example embodiment of the disclosure.

FIG. 2 is a perspective view of the frame of the children's play-yard apparatus shown in FIG. 1, with fabric or soft-goods cover and wall panels removed, showing the dynamic hinge frame structure, shown in its upright and expanded configuration.

FIGS. 3A-3D show a sequence of erection of the play-yard frame shown in FIG. 2, moving between a folded configuration and the upright and expanded configuration, and a detail of a dynamic hinge element according to an example embodiment of the disclosure.

FIGS. 4A-4E show a dynamic hinge element according to another example embodiment of the disclosure.

FIGS. 5A-5E show a dynamic hinge element according to another example embodiment of the disclosure.

FIGS. 6A-6E show a dynamic hinge element according to another example embodiment of the disclosure.

FIGS. 7A-7E show a dynamic hinge element according to another example embodiment of the disclosure.

FIGS. 8A-8D show a dynamic hinge element according to another example embodiment of the disclosure.

FIGS. 9A-9C show a bassinet apparatus having foldable support legs with dynamic hinges according to an example embodiment of the disclosure.

FIGS. 10A-10F show a frame structure for a play-yard or other assembly having foldable support legs with dynamic hinges according to another example embodiment of the disclosure.

FIGS. 11A-11E show a self-assembling play-yard having dynamic hinges according to another example embodiment of the disclosure.

FIGS. 12A and 12B show a self-assembling frame structure for a play-yard or other assembly having with locking dynamic hinges according to another example embodiment of the disclosure.

FIGS. 13A-13G show a locking dynamic hinge according to an example embodiment of the disclosure.

FIGS. 14A-14D show a children's play-yard apparatus having a folding frame incorporating dynamic hinges, according to another example embodiment of the disclosure.

FIGS. 15A and 15B show additional embodiments of dynamic hinges according to further example embodiments of the disclosure.

FIGS. 16A-16C show details of a frame assembly for a structure, having locking dynamic hinges according to another example embodiment of the disclosure.

FIGS. 17A-17C show another example embodiment of a dynamic hinge.

FIG. 18 shows a folding pet home having a folding frame incorporating dynamic hinges, according to another example embodiment of the disclosure.

FIGS. 19A and 19B show a folding umbrella incorporating a dynamic hinge mechanism according to another example embodiment of the disclosure.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

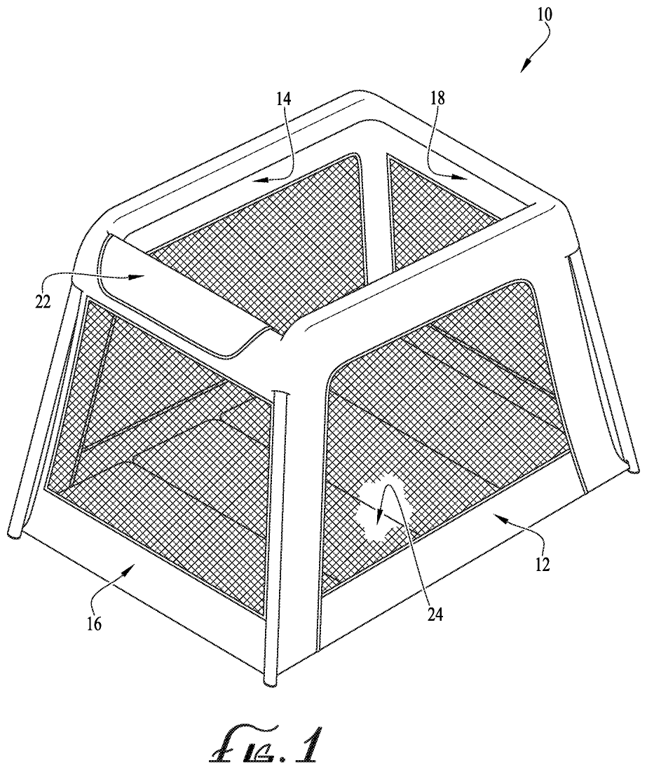

FIGS. 1-3 show an apparatus in the form of a children's play-yard 10, incorporating a frame structure 30 having dynamic hinge elements according to example embodiments of the present disclosure. The play-yard 10 generally comprises fabric or soft goods mounted to the frame 30, such as first and second side wall panels 12, 14 and first and second end wall panels 16, 18. The wall panels optionally comprise nylon or other fabric portions having mesh or screen insert portions for visibility and airflow. Optionally, the soft goods may include frame coverage panels 22 covering folding joints of the frame 30 to prevent contact with possible pinch points. A floor 24, such as for example a multi-panel folding padded floor, is optionally provided at the base or bottom of the play-yard 10. The play-yard 10 defines an interior contained space within which a child may rest or play, bounded by the wall panels and the floor, with a top opening for access to and from the contained space. In example embodiments, the frame structure of the apparatus comprises a plurality of hinged joints, and is foldable from an expanded use configuration into a more compact folded configuration for storage and transport. One or more dynamic hinges having elastic expansion members may be provided to assist in erecting or expansion, or to provide for self erection or expansion, of the apparatus. Expanding the frame operates to pull the soft goods components carried on the frame taut, in order to define an interior contained space. When the frame is fully expanded, the dynamic hinge optionally locks the frame into the assembled configuration. One or more fasteners or closure mechanisms such as straps, hook-and-loop (Velcro™) attachment material, snaps, zippers, buttons, etc., are optionally provided to retain the apparatus in the folded state against the expansion bias of the dynamic hinge until a user releases the fastener or closure to deploy the apparatus. In example embodiments, when the fasteners or closures are released, the outward or expansion bias of the dynamic hinge causes the frame to expand substantially automatically because of the tension being released on the elastic member of the hinge. Alternatively, the expansive biasing forces applied by the elastic member of the dynamic hinge may be selectively controlled to assist a user in expansion of the frame to erect the apparatus.

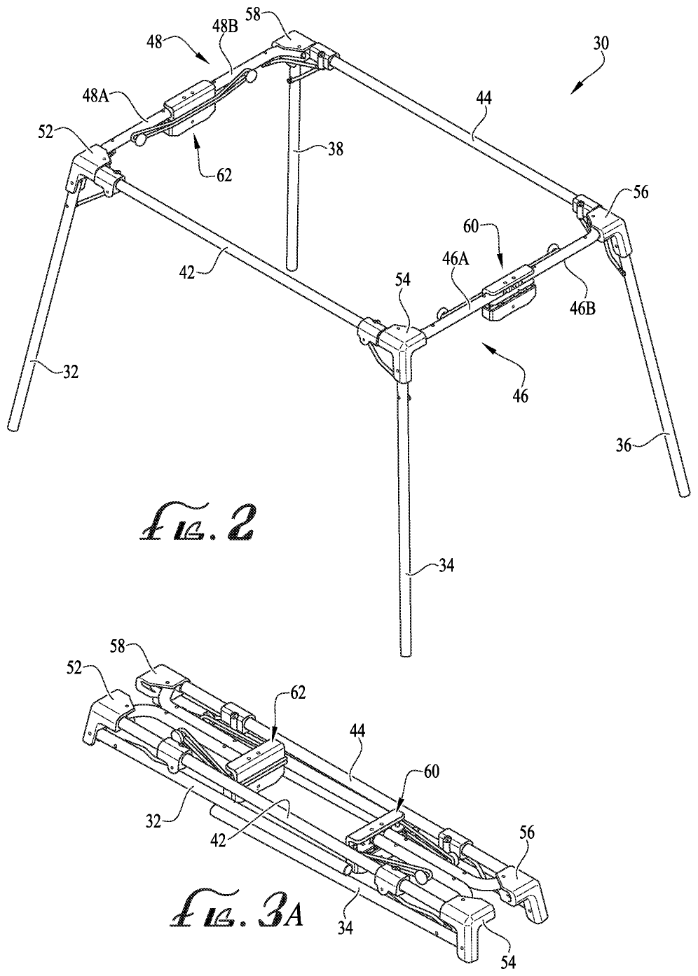

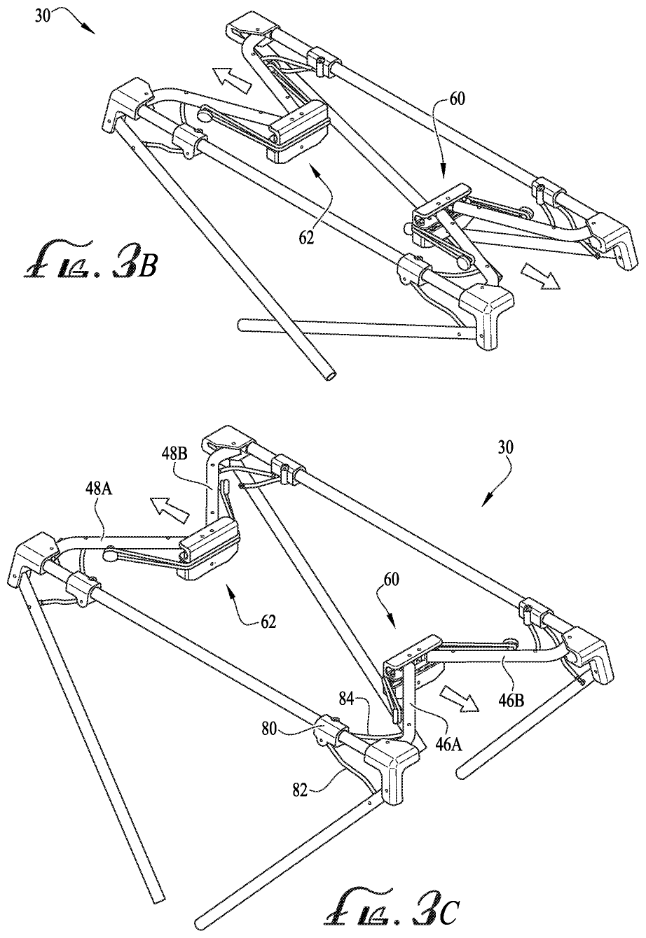

FIG. 2 shows additional detail of the frame structure 30 in its upright and expanded use configuration, with the soft goods wall and floor panels removed for clarity. The frame 30 generally comprises a 3-dimensional rectangular prismatic or frusto-pyramidal structure. The frame 30 comprises four generally upright corner post or leg members, 32, 34, 36, 38; first and second upper side rails 42, 44; and first and second upper end rails 46, 48. The upper end rails 46, 48 each comprise first and second end rail segments 46A, 46B and 48A, 48B. Corner brackets 52, 54, 56, 58 couple the frame members at upper corners of the frame structure 30. Each corner bracket 52, 54, 56, 58 couples with a respective one of the legs 32, 34, 36, 38, for example by engagement of an upper end of the leg within a lower receiver portion of the bracket; with a respective one of the side rails 42, 44, for example by engagement of an end of the side rail in a first transverse receiver portion of the bracket; and with a respective one of the end rail segments 46A, 46B and 48A, 48B, for example by engagement of an end of the end rail segment in a second transverse receiver portion of the bracket. The legs 32, 34, 36, 38 are pivotally or foldably coupled to their respective corner brackets 52, 54, 56, 58 by a hinge or pin coupling, allowing the legs to be folded from the upright and expanded use configuration shown in FIG. 2 into the more compact folded storage and transport configuration shown in FIG. 3A. The outer ends of the end rail segments 46A, 46B and 48A, 48B are also pivotally or foldably coupled to their respective corner brackets 54, 56, 52, 58 by a hinge or pin coupling, allowing the end rail segments to be folded from the upright and expanded use configuration into the storage and transport configuration.

The inner ends of the end rail segments 46A, 46B and 48A, 48B are coupled to one another by dynamic hinges 60, 62. FIGS. 3B, 3C and 3D show additional detail of the structure and operation of the dynamic hinges 60, 62. With reference to dynamic hinge 60 shown in FIG. 3D, the inner ends of the end rail segments 46A, 46B are pivotally or foldably coupled by hinges or pin joints within an exterior receiver channel of a hinge bracket 66. An elastic biasing member 70 is coupled in tension between mounting lugs 72, 74 mounted to medial portions of the end rail segments 46A, 46B, and extends over and across an interior face of the hinge bracket 66. In example forms, the elastic biasing member 70 comprises one or more heavy duty rubber band(s), bungee cord(s), rubber tubing (such as latex rubber surgical tubing), or other resilient and flexible elastic materials or elements. In alternate embodiments, the elastic member(s) may comprise metal springs such as coil springs, leaf springs, torsion springs, tension springs or the like, resilient flexible metal or plastic elements or structural components, or other resilient biasing means. The elastic biasing member 70 applies an outwardly directed force on the interior face of the hinge bracket 66, causing the dynamic hinge to bias the end rail segments 46A, 46B toward the upright and expanded use configuration of the play-yard 10 shown in FIG. 2, to assist or cause the play-yard to move from the folded configuration (FIG. 3A), through the partially erected configurations (FIGS. 3B, 3C), to the use configuration (FIG. 2), allowing the play-yard to be partially or fully self-erecting. The outer ends of the end rail segments 46A, 46B and 48A, 48B are bent or curved at an obtuse angle near their couplings with the corner brackets 52, 54, 56, 58. Each corner joint of the frame 30 also includes a sleeve 80 slidably mounted on one of the upper side rails 42, 44; a leg linkage 82 pivotally coupled at one end to the sleeve, and pivotally coupled at the other end to one of the legs 32, 34, 36, 38; and an end rail linkage 84 pivotally coupled at one end to the sleeve, and pivotally coupled at the other end to one of the end rail segments 46A, 46B and 48A, 48B. The sleeves 80 are configured to slide freely along the upper side rails. As the dynamic hinges 60, 62 expand (FIGS. 3A to 3C), the end rail linkages 84 pull the sleeves 80 toward the corner brackets of each corner joint, and the leg linkages 82 in turn extend the legs 32, 34, 36, 38 from their folded configuration to their upright configuration. In this manner, the frame 30 is substantially self-erecting upon release from its folded configuration, with the dynamic hinges 60, 62 extending the end rails outwardly and also (through operation of the sleeve and linkage mechanism) extending the legs in response to the end rail extension.

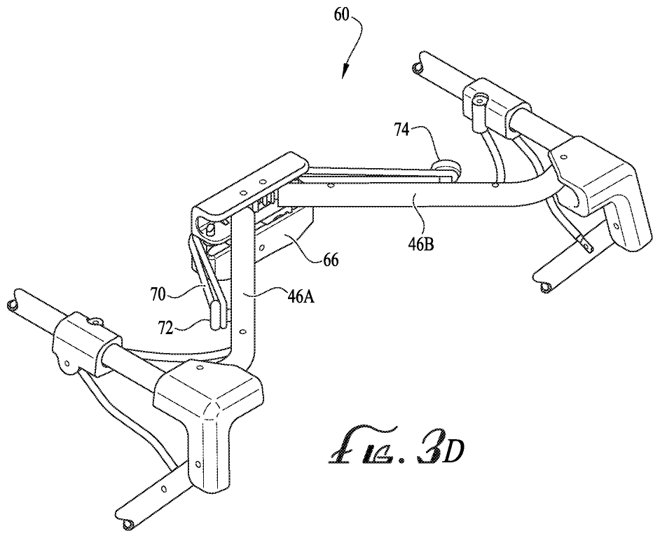

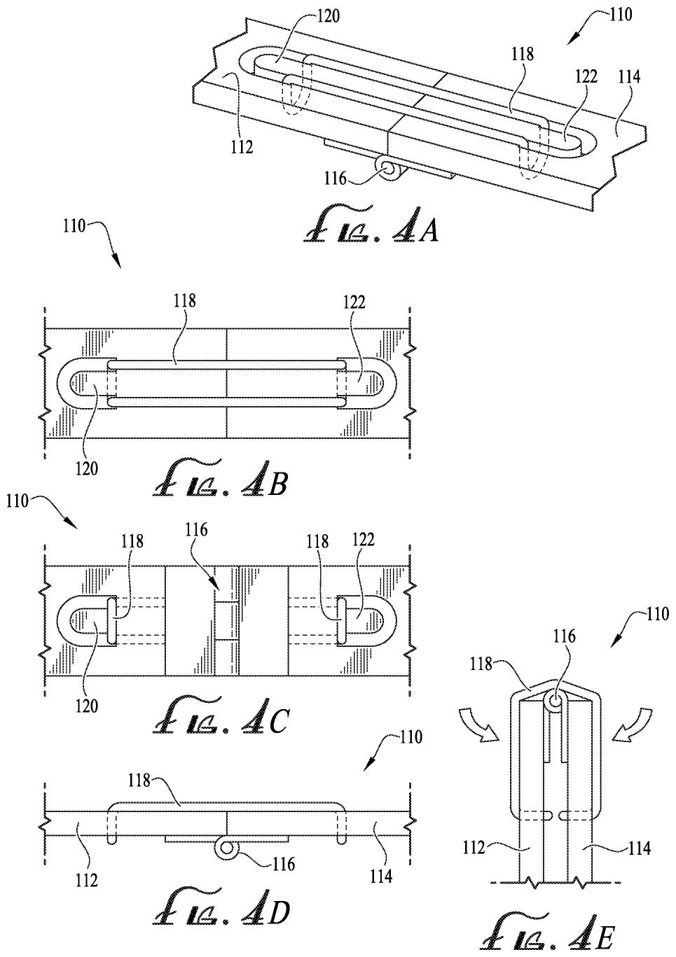

FIGS. 4-8 show details of a number of alternative embodiments of a dynamic hinge or joint. For example, FIGS. 4A-4E show a dynamic hinge or joint 110 according to an example embodiment of the disclosure. The dynamic hinge 110 may be used to couple together and allow folding of one or more frame portions of an apparatus including, but not limited to, a play yard, bassinet, crib, highchair, tent, chair, bed, table, or any other piece of furniture or equipment that may require a hinged fold. In example embodiments, an apparatus may comprise one or more dynamic hinges 110. Optionally, the dynamic hinge may be integrally formed with the apparatus or formed separately and assembled together with the apparatus. The dynamic hinge 110 comprises a first frame member 112 and a second frame member 114. The first and second frame members 112, 114 are coupled together by a hinge 116 such as a butt hinge. In example embodiments, any suitable hinge may be used, for example, a piano hinge, butterfly hinge, flush hinge, and the like. The dynamic hinge 110 further includes a resilient member 118. When the frame members are folded, as shown in FIG. 4E, the resilient member 118 is under maximum tension. When the frame members are released, as shown in FIGS. 4A-4E, the resilient member 118 biases the frame portions 112, 114 into an open, expanded, or use configuration. The resilient member 118 is dimensioned such that tension exists in the resilient member even when the frame portions 112, 114 are in the expanded configuration in order to hold tension across the fold point or joint. In example embodiments, the resilient member 118, when coupled to the frame portions 112, 114, is adapted to assist the user with assembling the frame into the expanded configuration in a substantially single, automatic step by releasing the tension holding the frame members in the folded configuration. In example embodiments, the resilient member 118 is coupled to a first slotted mounting tab 120 of the first frame member 112 and to a second slotted mounting tab 122 of the second frame member 114. In example embodiments, the resilient member 118 comprises an elastic or rubber band in the form of a loop or ring, such that opposite ends of the loop or ring can be retained over the mounting tabs 120, 122. The resilient member 118 is resilient enough to allow substantially automatic assembly of the frame portions into the use configuration and strong enough to not break under the weight or usage of a user. The resilient member 118 is optionally releasably or substantially permanently attached to the frame portions 112, 114. In a preferred embodiment, the resilient member 118 is releasably coupled to the frame portions to allow for replacement of the resilient member in the event the resilient member breaks, the resilient member is overstretched, or the resilient member has been used for a predetermined amount of time. The bias of the resilient member 118 may be overcome by one or more fasteners either coupled to the frame portions or to another portion of the apparatus to allow for fastening of the frame portions in the folded configuration for storage or transport. The resilient member 118 and the hinge 116 work together to not allow over rotation of the frame portions when transitioning between the expanded and the collapsed configurations.

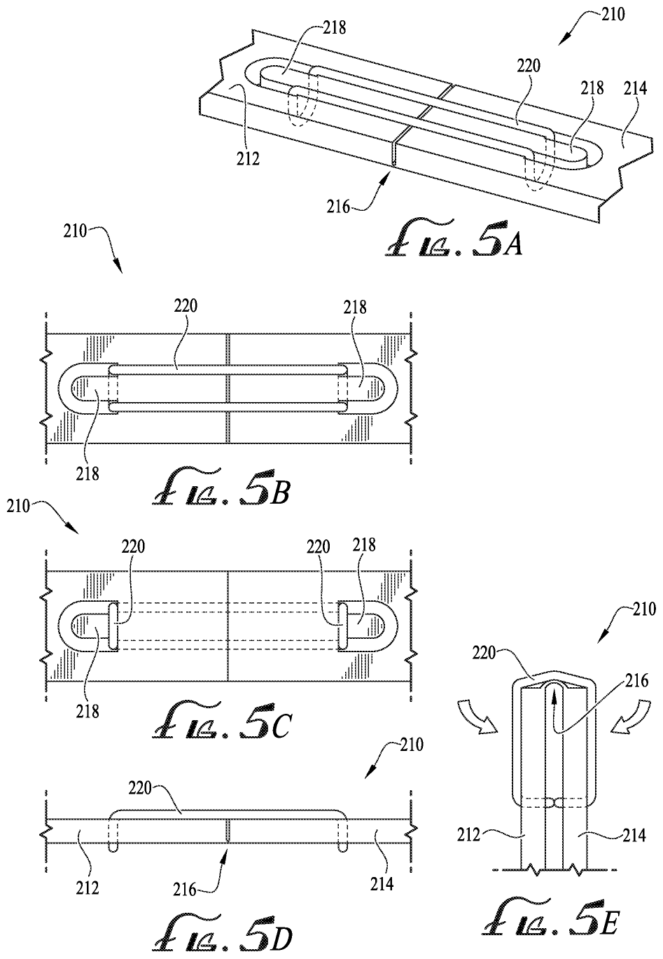

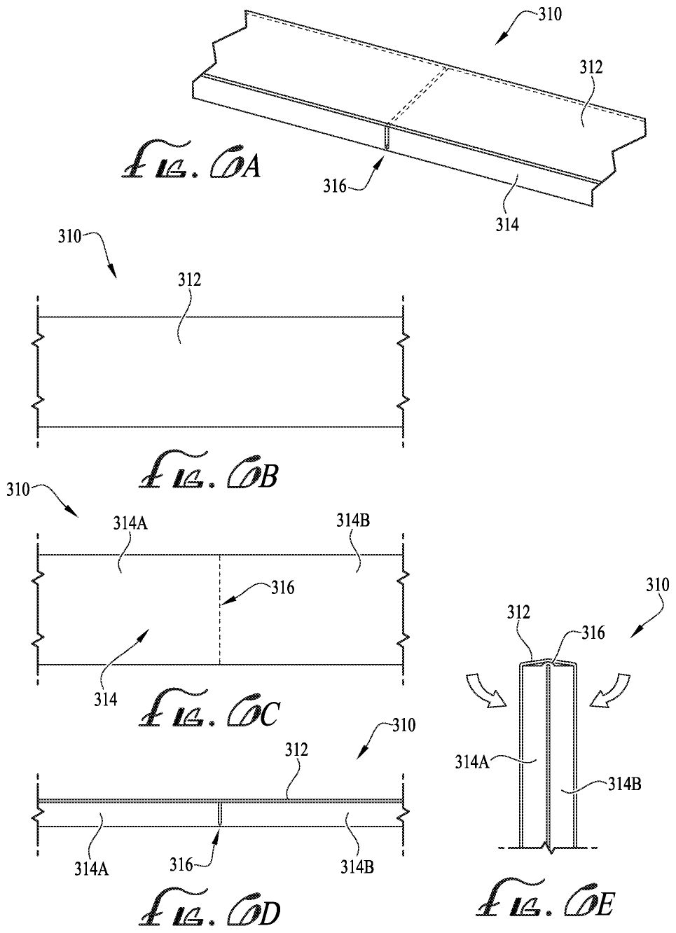

FIGS. 5A-5E depict a dynamic hinge 210 according to another example embodiment of the disclosure. In this embodiment, the dynamic hinge 210 comprises a first frame portion 212 and a second frame portion 214 that are coupled together by a living hinge 216. The first and second frame portions 212, 214 each comprise a slotted mounting tab 218 for receiving a resilient member 220 such as an elastic band. Similar to the dynamic hinge 110 shown in FIGS. 4A-4E, the resilient member 220 of the embodiment shown in FIGS. 5A-5E biases the frame portions 212, 214 into an open or assembled position. The frame portions may be collapsed or folded into the closed configuration by overcoming the bias of the resilient member 220 and fastening the apparatus into the closed or folded configuration. For example, a user may use one or more ties, Velcro, snaps, buttons, etc. to releasably fasten the apparatus in the folded configuration. When the one or more fasteners are released, the resilient member 220 triggers the frame to substantially automatically return to its open or assembled configuration, enabling a self-assembling or self-erecting structure.

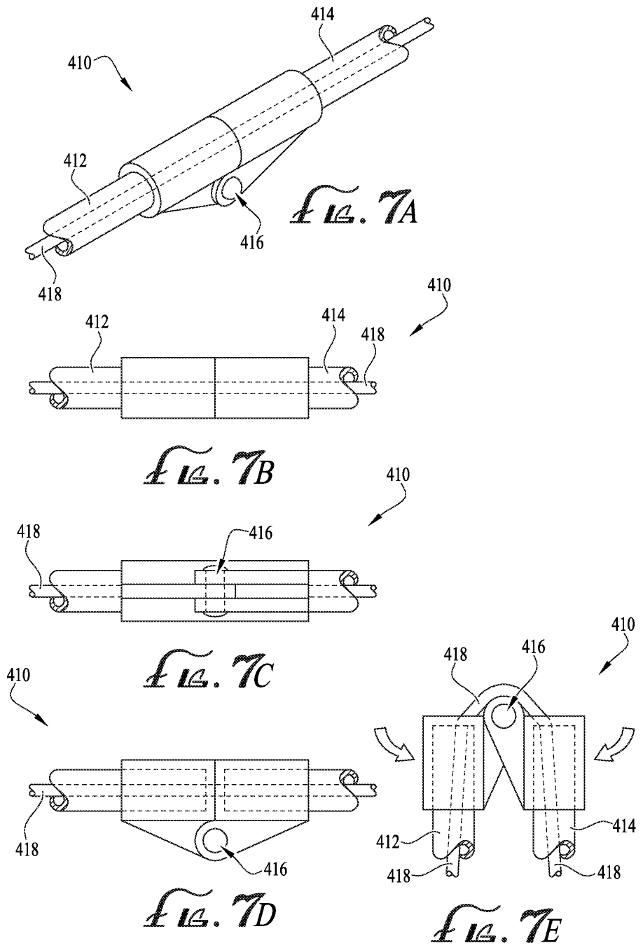

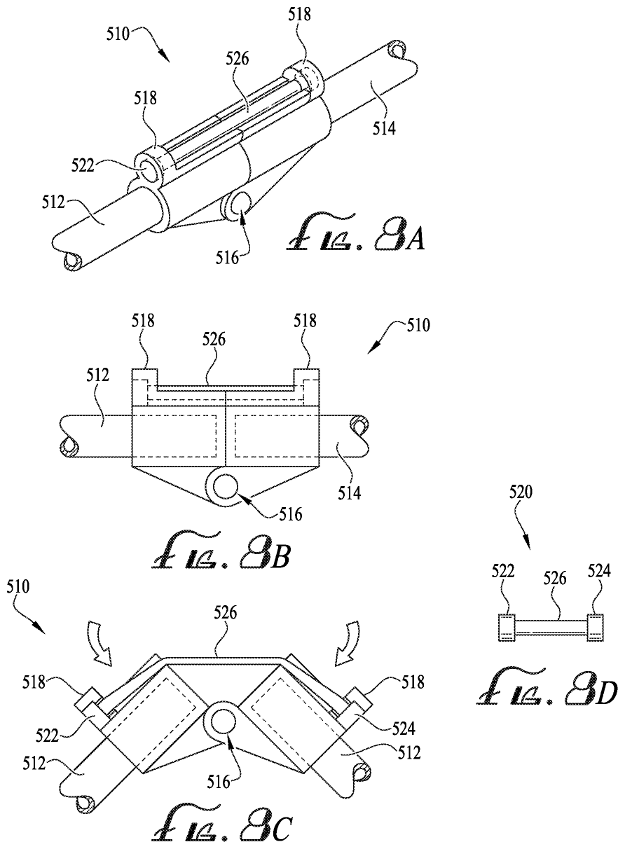

FIGS. 6A-6E depict a dynamic hinge 310 according to another example embodiment of the disclosure. In this embodiment, the dynamic hinge 310 comprises an integral single part having an elastic sheet or layer 312 partially detached and partially joined to a rigid panel or layer 314. The rigid panel or layer 314 comprises a continuous joined component comprising two segments 314A, 314B having an integral or unitary living hinge 316 proximate the detached portion of the rigid layer and the elastic layer 312, or alternatively may comprise two or more separate segments held together only by the elastic sheet or layer 312. Similar to the previous embodiments, the elastic layer 312 biases the rigid layer 314 into the open or assembled position. In order to fold the dynamic hinge 310, a user may overcome the bias of the elastic layer 312 and latch the rigid layer 314 in the closed or folded position.

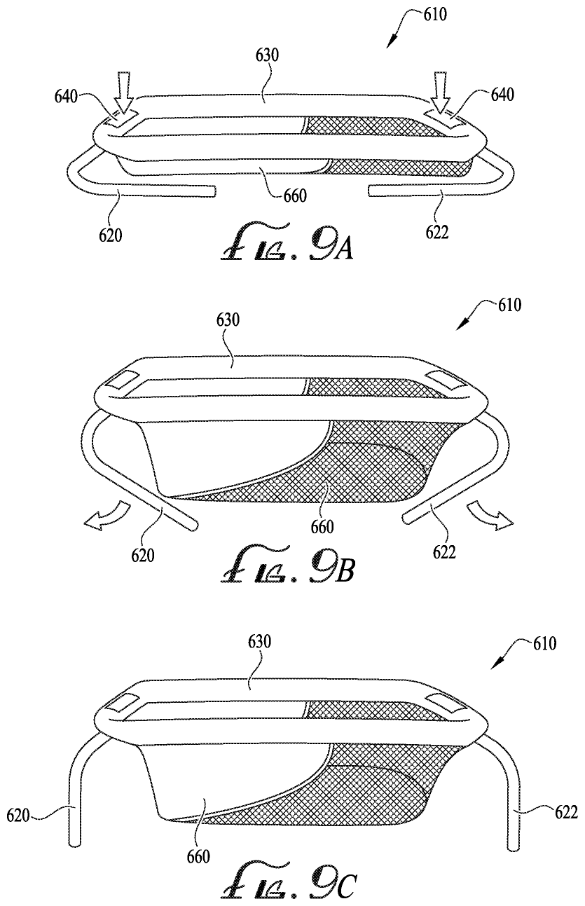

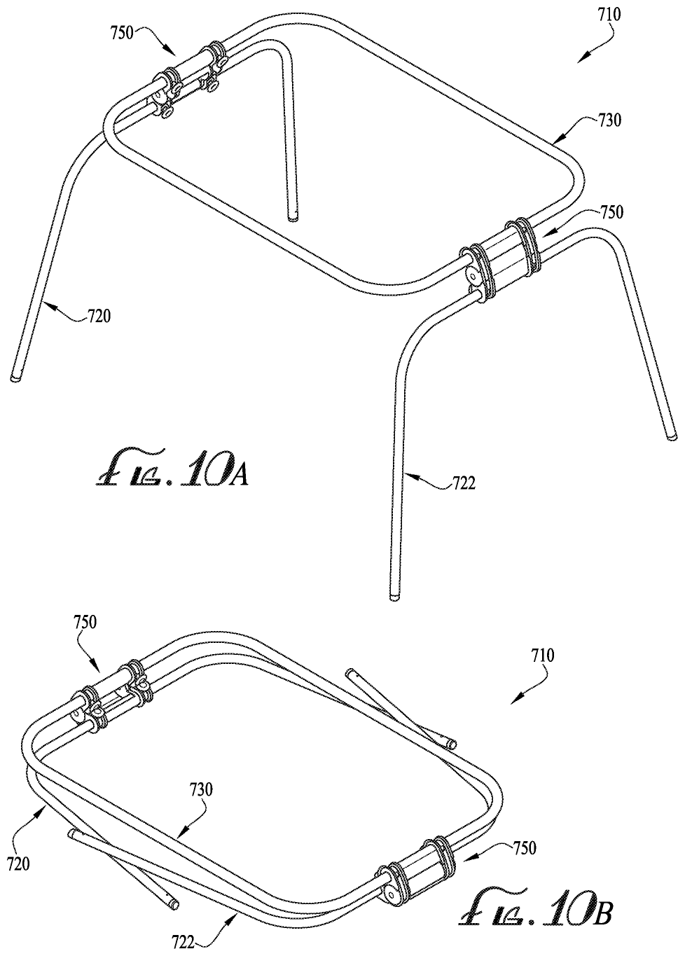

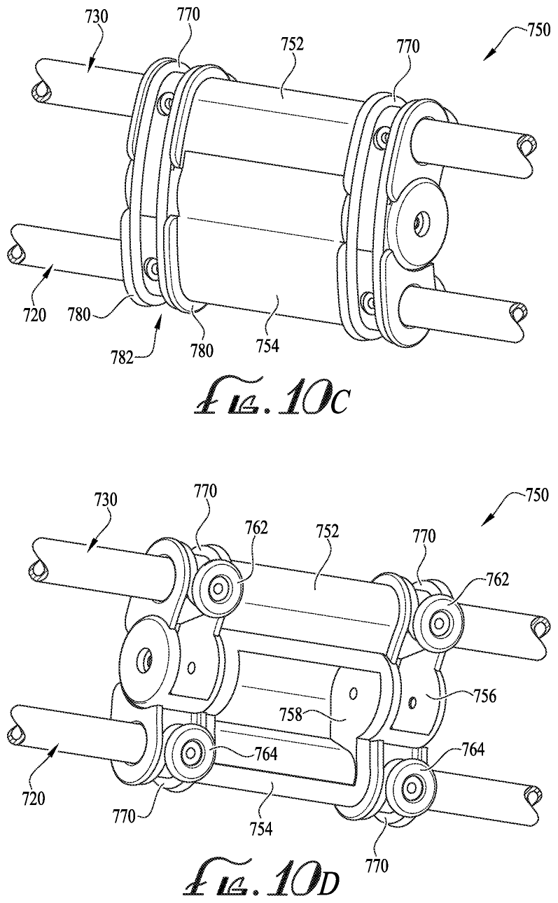

FIGS. 7A-7E depict a dynamic hinge 410 according to another example embodiment of the disclosure. In this embodiment, the dynamic hinge 410 is adapted for use with a tubular structural frame member of an apparatus or assembly. The dynamic hinge 410 comprises a first tubular frame portion 412 and a second tubular frame portion 414. The frame portions 412, 414 are operatively coupled together by a hinge 416. In example embodiments, an elastic cord 418 passes internally through the hollow channel or internal region of the tubular frame portions 412, 414 at the hinge ends. A first end of the cord is anchored to a portion of the first frame portion 412 or other anchoring structure at a location spaced a distance from the hinge end, and a second end of the cord is anchored to a portion of the second frame portion 414 or other anchoring structure at a location spaced a distance from the hinge end. The elastic cord 418 is retained in tension to bias the tubular frame portions toward an open or assembled position (FIGS. 7A-7D). Similar to the previous embodiments, to fold the dynamic hinge 410, a user may overcome the bias of the elastic cord 418 to collapse the tubular frame portions and optionally may fasten the frame into the closed or folded position (FIG. 7E).

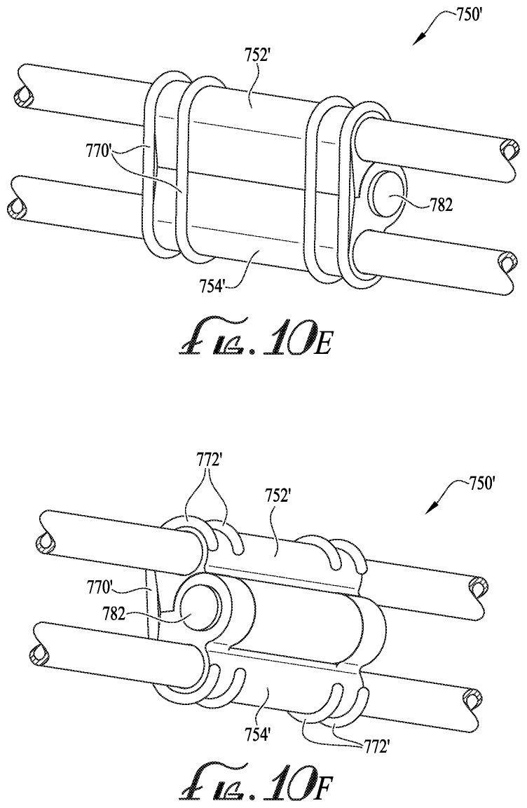

FIGS. 8A-8D depict a dynamic hinge 510 according to another example embodiment of the disclosure. In this embodiment, the dynamic hinge 510 is also adapted for use with tubular elements or rods of a structural frame. The dynamic hinge 510 comprises a first tubular or otherwise configured frame portion 512 and a second tubular or otherwise configured frame portion 514. The first and second frame portions 512, 514 are coupled together by a hinge 516 located along a first side of the joint between the first and second portions. In example embodiments, the first and second frame portions 512, 514 each comprise a cartridge mount 518 located along an opposite second side of the joint, for releasably receiving a replaceable tension cartridge 520. The replaceable tension cartridge 520 comprises first and second posts or receivers 522, 524 for mounting an external elastic member 526. The elastic member 526 and/or the entire replaceable tension cartridge 520 may be removed and replaced after a particular period of use or in the event the elastic member 526 breaks or is overstretched. The replaceable tension cartridge 520 is retained in tension and biases the frame portions 512, 514 into an open or extended assembled configuration (FIG. 8B). A user may overcome the bias of the replaceable tension cartridge to fold the frame portions into a closed or folded position (FIG. 8C shows a partially closed position). A fastener such as a pair of straps on the first and second frame portions may optionally be used to retain the frame portions in the closed position.

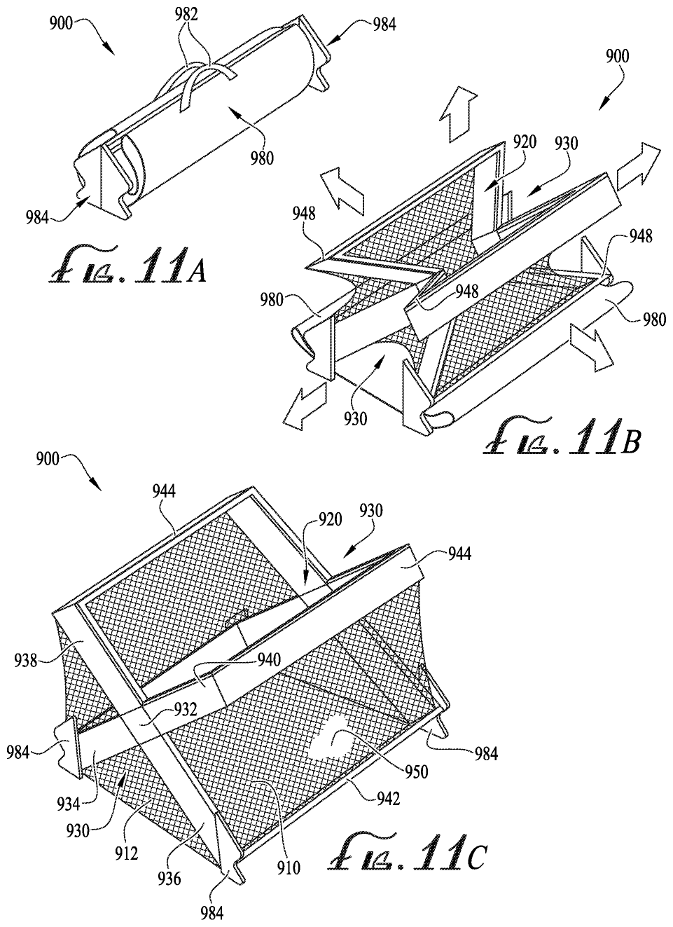

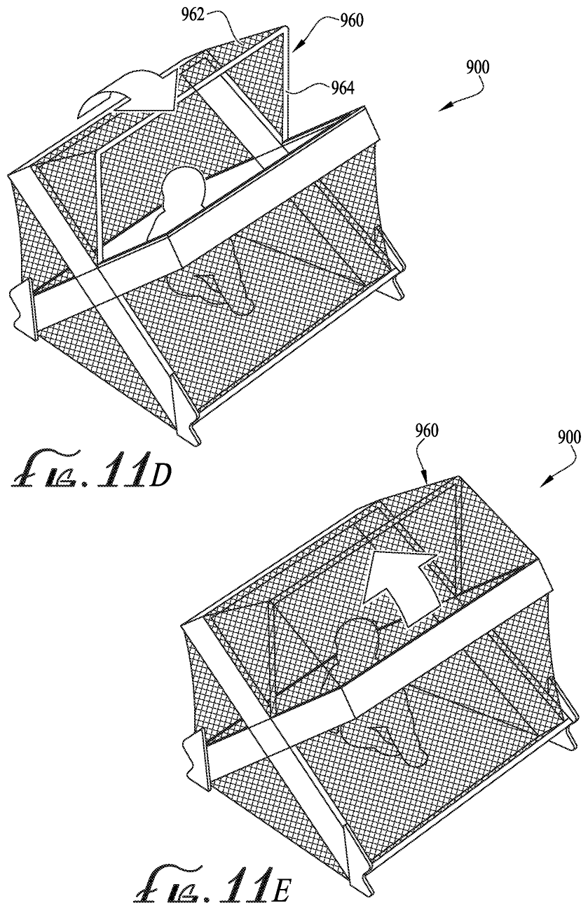

FIGS. 9A-9C show a self-erecting apparatus in the form of a children's bassinet 610 according to an example embodiment of the disclosure. The bassinet 610 generally comprises a frame assembly incorporating one or more dynamic hinges, and a soft goods cover. The frame comprises first and second generally U-shaped leg members 620, 622, hingedly or pivotally coupled at opposite ends of a rectangular or oval upper frame ring 630. The leg members 620, 622 are preferably coupled to the frame ring 630 by dynamic hinges according to example embodiments disclosed herein, whereby the bassinet 610 is biased by the dynamic hinges to expand from a folded storage configuration (FIG. 9A) to an expanded use configuration (FIG. 9C). One or more locking and release mechanisms 640 are optionally provided, to retain the bassinet 610 in its folded configuration against the bias of the dynamic hinges until released by a user, and/or to retain the bassinet in its expanded configuration during use. In the depicted embodiment, release actuators of locking and release mechanisms 640 are positioned at opposite sides of the bassinet 610, such that two-handed operation is required, to prevent inadvertent release or collapse of the bassinet in use. The soft goods cover 660 generally comprises flexible fabric and/or mesh walls and a floor, suspended from the upper frame ring 630.

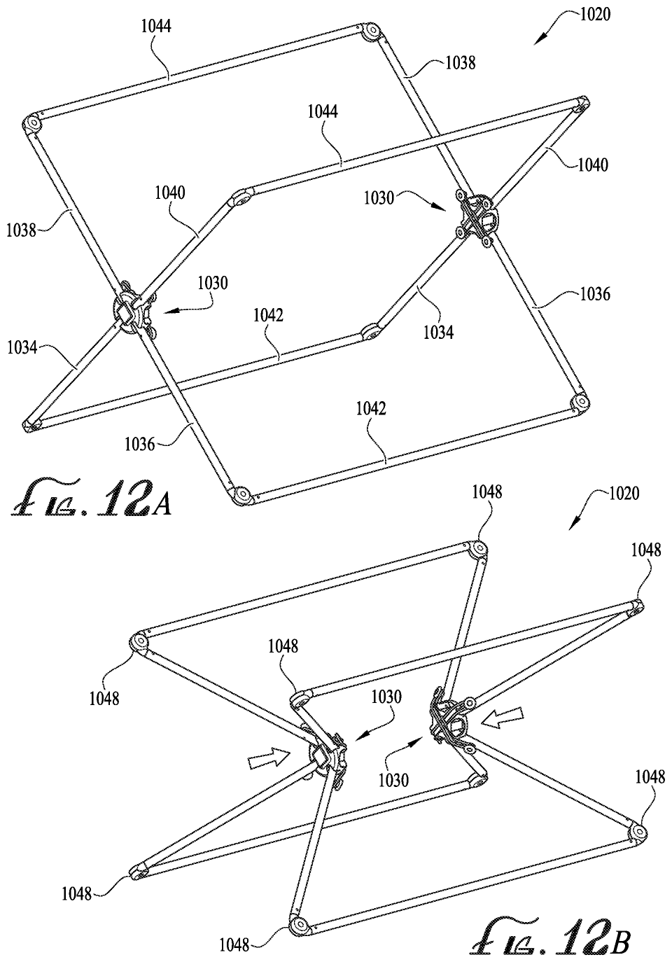

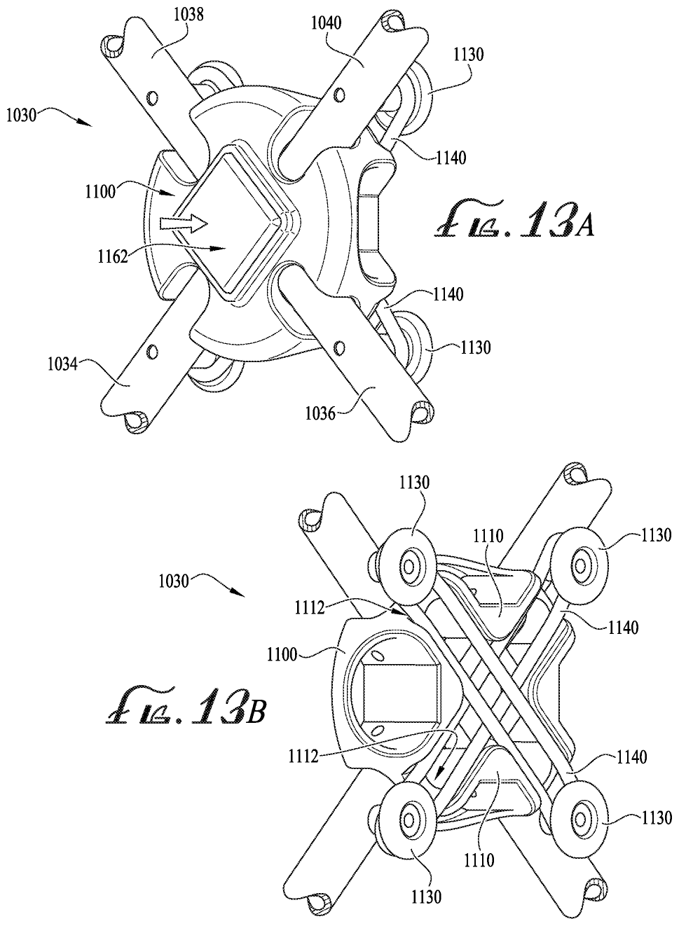

FIGS. 10A and 10B show a frame assembly 710 for a children's bassinet, play-yard, or other apparatus or structure according to an example embodiment of the disclosure. The frame assembly 710 comprises first and second generally U-shaped leg members 720, 722, hingedly or pivotally coupled at opposite ends of an upper frame ring 730. Each of the leg members 720, 722 includes first and second generally upright leg or post portions, extending from opposite ends of a horizontal or transverse upper or medial portion. The leg members 720, 722 are preferably coupled to the frame ring 730 by dynamic hinges 750, which bias the frame assembly 710 toward its expanded or upright use configuration (FIG. 10A), and allow folding of the frame assembly into a compact folded storage and transport configuration (FIG. 10B). FIGS. 10C and 10D show further details of a dynamic hinge 750 according to an example embodiment. The dynamic hinge 750 includes a first connection flange 752 mounted to a first frame component (upper frame ring 730 in the depicted embodiment), and a second connection flange 754 mounted to a second frame component (transverse portion of leg member 720 in the depicted embodiment). The first and second connection flanges 752, 754 include interconnecting hinge linkages 756, 758 pivotally coupling the first and second connection flanges to one another forming a hinge joint allowing the first and second frame components to move pivotally between folded and expanded configurations. The first connection flange 752 comprises at least one (two depicted) first or upper retainer collars 762, and the second connection flange 754 comprises at least one (two depicted) second or lower retainer collars 764. One or more elastic member(s) in the form of an elastic loop or band 770 is retained in tension between the upper retainer collars 762 and the lower retainer collars 764, to bias the first and second frame components toward their expanded configurations. As depicted, a first end loop of the elastic band 770 is looped around the first retainer collar 762, and a second end loop of the elastic band is looped around the second retainer collar 764. The first and second connection flanges 752, 754 optionally include one or more (two pairs each depicted) outwardly projecting fins 780 defining retention channels 782 therebetween, through which the elastic loop or band 770 extend. The retainer collars 762, 764 are positioned on a first face or side of the dynamic hinge 750, for example on the interior face in the depicted embodiment, and the opposite (exterior depicted) face defines a contact surface along which an intermediate portion of the elastic member 770 extends. The interconnecting hinge linkages 756, 758 provide an offset between the first and second connection flanges 752, 754, so that movement of the frame 710 from its expanded configuration to its folded configuration stretches the elastic member 770, resulting in an increased elastic tension and a biasing force toward the expanded configuration. The exterior contact surfaces within the retention channels 782 optionally define a substantially smooth convex profile along which the intermediate portion of the elastic member 770 extends, to reduce wear on the elastic member. FIGS. 10E and 1OF show an alternate embodiment of a dynamic hinge 750′, substantially similar to the above-described embodiment, but with elastic members 770′ having hooked ends 772′ for retaining the elastic members on the first and second connection flanges 752′, 754′, instead of retainer collars. A lock and release mechanism is optionally provided, with an internal latching mechanism engaging to retain the hinge 750′ in its expanded position until a user releases the latch by pressing or squeezing the actuator button 782.

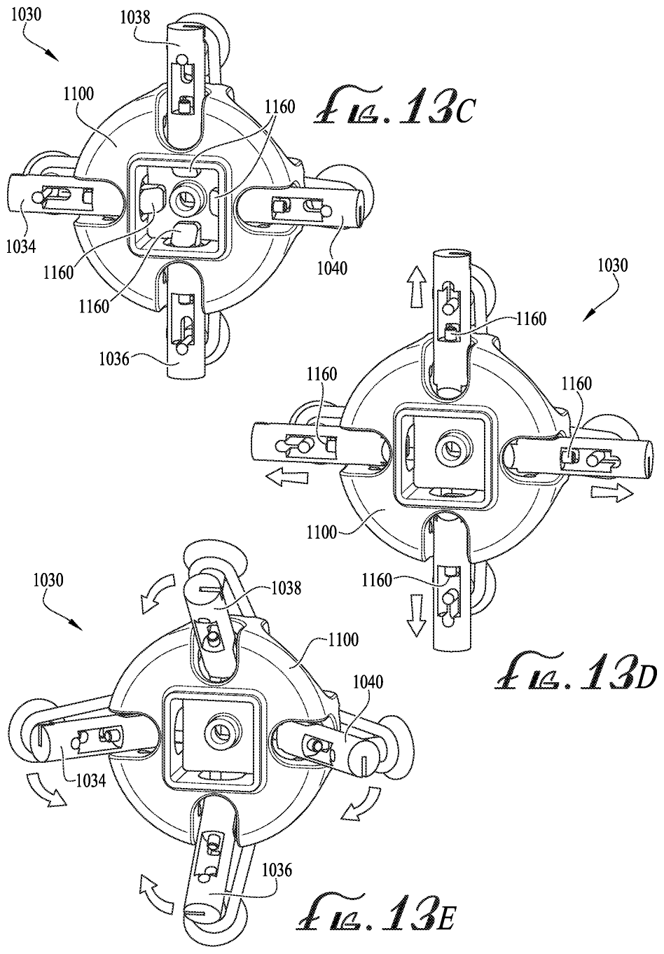

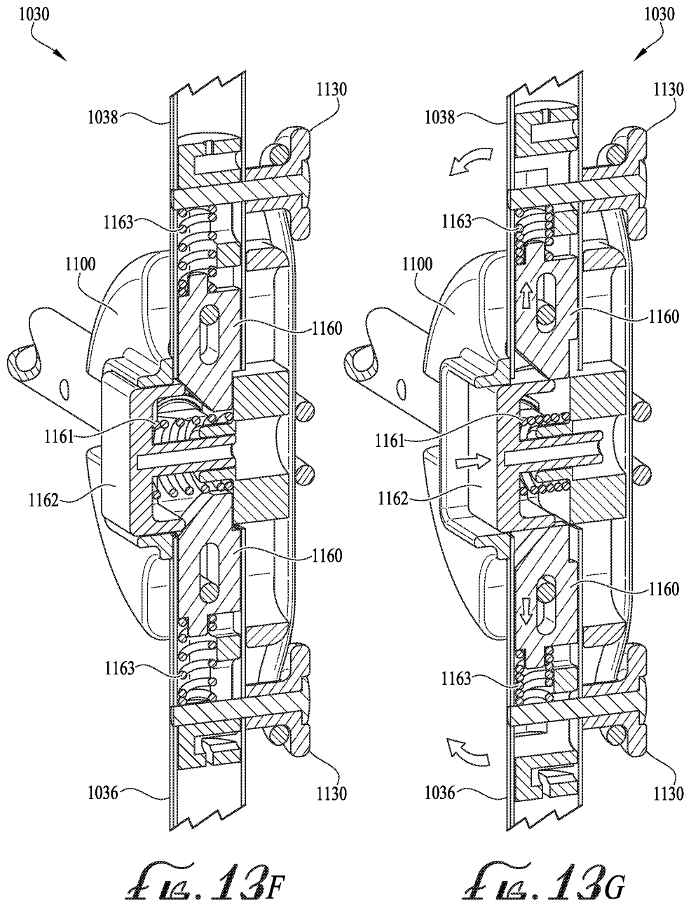

FIGS. 11A-11E show a children's play-yard 900, according to another example embodiment of the disclosure. The play-yard 900 comprises mesh and/or fabric sidewall and endwall panels 910, 912, supported by a foldable support frame 920, and optionally further comprises a floor 950 and a canopy 960. The play-yard 900 can be folded to a compact storage and transport configuration (FIG. 11A), and the frame 920 includes one or more dynamic hinges enabling the play-yard to at least partially self erect when released by a user from its folded configuration, into an expanded configuration (FIG. 11C). In example embodiments, the play-yard 900 forms a generally cubical or rectangular prismatic three-dimensional enclosure in its expanded configuration, enclosing a contained space within with a child can rest and play. Optionally, the play-yard 900 further comprises a carrying case or cover 980 including one or more handles 982 and end panels 984, for enclosing and carrying the play-yard in the folded configuration, and for retaining the play-yard in the folded configuration against the bias of the dynamic hinges toward the expanded configuration. In example embodiments, the carrying case 980 forms an integral part of the play-yard 900, with its outer cover portion forming the floor 950 of the play-yard, and its end panels 984 forming support feet to support the frame 920 of the play-yard upon a floor or other underlying support surface.

The foldable support frame 920 of the play-yard 900 can take various forms and be fabricated from a variety of different materials. In the example embodiment depicted in FIGS. 11A-11E, the frame 920 comprises four-way, cruciform dynamic hinge mechanisms 930 on each of the endwalls 910, 912. The dynamic hinge mechanism 930 comprises a diamond, square or rectangular central hub 932, with four cross-arm members 934, 936, 938, 940 extending outwardly from the hub in an X-shaped array. A pair of lower frame siderails 942 extend between the lower cross-arm members 934, 936 of the dynamic hinges at each end of the play-yard; and a pair of upper frame siderails 944 extend between the upper cross-arm members 938, 940 of the dynamic hinges at each end of the play-yard. In example embodiments, a living hinge can be formed between the hub 932 and the inner ends of the cross-arms 934, 936, 938, 940, fabricated as an integral or unitary component, with the internal elasticity or resilience of the material itself biasing the dynamic hinges 930 outwardly toward the expanded configuration. In alternate embodiments, one or more dynamic hinge arrangements utilizing elastic members, such as for example as shown and described above with reference to FIGS. 4-8 can be provided, or as further described below. Dynamically biased or standard unbiased hinges 948 are also provided between the outer ends of the cross-arms 934, 936, 938, 940 and the lower and upper frame siderails 942, 944.

In use, a user may release a closure of the carrying case or cover 980 to erect the play-yard 900 for use. Upon release, the dynamic hinges 930 bias the frame 920 outwardly and upward toward its expanded configuration, either causing the play-yard 900 to self-erect, or assisting the user in erecting the play-yard. The play-yard 900 expands from the compact folded state (FIG. 11A), through an intermediate or partially erected state (FIG. 11B), and into its fully expanded state (FIG. 11C) for use. After use, the user can fold the play-yard 900 back into its folded state by pressing the dynamic hinges 930 inwardly and compressing the frame 920 downwardly, and re-closing the carrying case or cover 980 to retain the play-yard in its folded state until the next use.

In some embodiments, an extensible and retractable sunscreen or canopy 960 is optionally provided, as shown in example form in FIGS. 11D and 11E. The canopy 960 may comprise a mesh or fabric panel or shell 962, supported by a canopy frame member 964, which is hingedly or detachably mounted to the hub 932 or other portion of the play-yard frame 920. The canopy 960 may be dynamically biased toward its open or closed position, and detachably retained in the other position against that bias by hook-and-loop, clip, snap or other releasable closure means, or may be freely movable between the open and closed positions by manual operation.

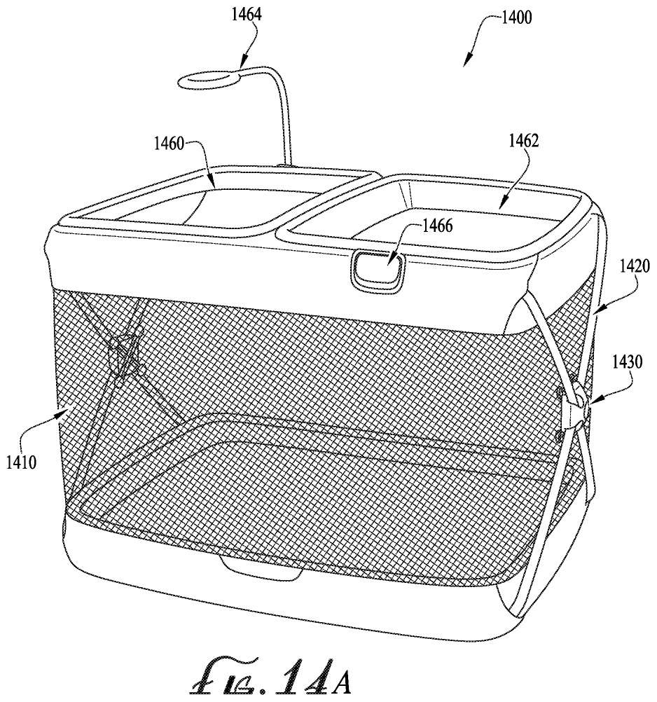

FIGS. 12A and 12B show another example embodiment of a frame 1020 and associated dynamic hinge structure 1030 for a play-yard or other apparatus. Similar to the above described embodiment, the frame 1020 defines a cubic or rectangular prismatic three-dimensional bounded interior containment space with four cross-arm members 1034, 1036, 1038, 1040 arranged in an X-shaped array at each end, and with lower and upper frame siderails 1042, 1044 extending between the outer ends of the cross-arms at the top and bottom of each side. Hinges 1048 are similarly provided between the outer ends of the cross-arms 1034, 1036, 1038, 1040 and the lower and upper frame siderails 1042, 1044. The frame is foldable from its expanded or use configuration (FIG. 12A) into a compact folded storage and transport configuration, by pressing the dynamic hinge elements 1030 inwardly toward one another and folding the frame down and inwardly as shown in FIG. 12B.

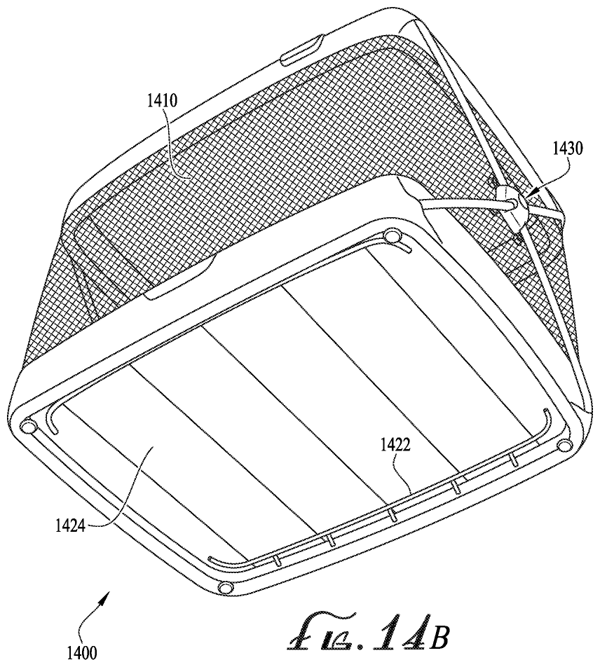

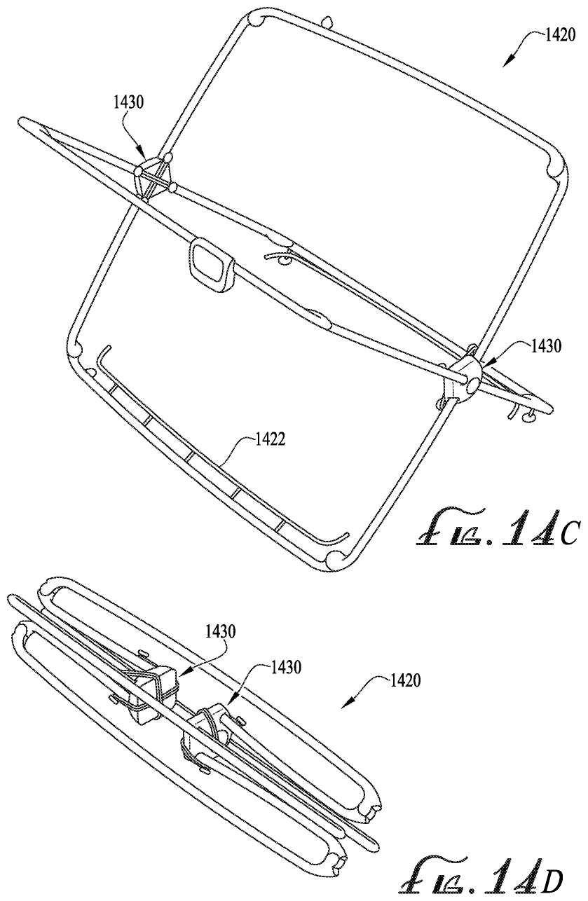

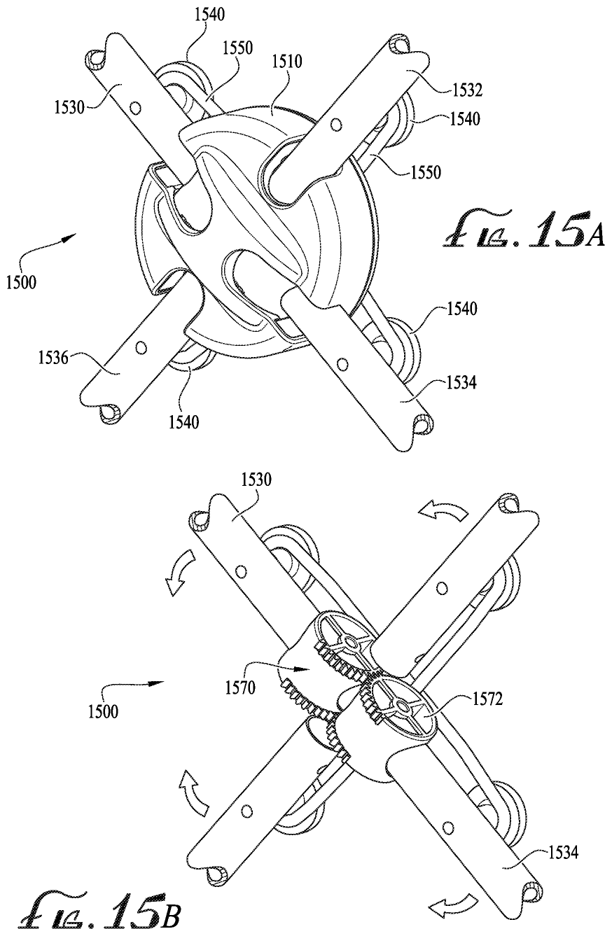

FIGS. 13A-13G show additional details of the dynamic hinge 1030, according to another example embodiment. The inner ends of the cross-arms 1034, 1036, 1038, 1040 are pivotally or hingedly coupled to a central hub 1100, for example by pin couplings or hinged joints. Retainer collars 1130 are affixed to each of the cross-arms 1034, 1036, 1038, 1040 proximal the inner ends of the cross-arms near the hub 1100. One or more resilient elastic members such as elastic loops or bands 1140 are engaged in cross-wise fashion between the retainer collars of the cross-arms 1034, 1036, 1038, 1040, for example engaged between the retainer collars of the lower left cross-arm 1034 and the upper right cross-arm 1040, and between the retainer collars of the lower right cross-arm 1036 and the upper left cross-arm 1038. The hub 1100 includes four recessed sockets with bearing surfaces configured to allow the cross-arms 1034, 1036, 1038, 1040 to pivot outwardly relative to the hub (see FIG. 12B) through a range of motion of about 90°, and to prevent pivotal movement of the cross-arms inwardly relative to the hub. In this manner, when the frame 1020 is fully folded, the cross-arms 1034, 1036, 1038, 1040 are generally aligned and parallel with one another, with the hub 1100 retracted inwardly and the cross-arms extending outwardly; and when the frame is fully expanded, the cross-arms are positioned cross-wise to one another and generally in planar alignment with the hub and with one another, with adjacent cross-arms spaced about 90° from one other and diagonally opposed cross-arms aligned at 180° from one another (FIG. 12A). The retainer collars 1130 and elastic bands 1140 are mounted on the interior or inwardly facing sides of the hubs 1100, so that the tension forces applied by the elastic bands bias the hubs 1100 outwardly and thereby bias the frame 1020 toward its expanded configuration. When the frame 1020 is folded, the pivotal movement of the cross-arms 1034, 1036, 1038, 1040 stretches the elastic bands 1140, increasing the inwardly directed tension forces applied on the retainer collars, thereby pulling the cross-arms toward the expanded configuration. As seen best with reference to FIG. 13B, the interior faces of the hubs 1100 of the dynamic hinges 1030 optionally comprise outwardly projecting fins or corner projections 1110 defining crosswise retention channels 1112 therebetween, through which the elastic bands 1140 extend.

The dynamic hinges 1030 optionally further comprise a locking and release mechanism, shown in example form with reference to FIGS. 13A and 13C-13G. A spring-biased latch 1160 is provided at the inner end of each of the cross-arms 1034, 1036, 1038, 1040. The latches 1160 extend under the biasing influence of latch springs 1163, and engage corresponding abutment surfaces of the hub 1100 when the frame is in its expanded configuration with the cross-arms 1034, 1036, 1038, 1040 extended, to lock the frame in the expanded configuration (FIG. 13C, 13F). To release the locking mechanism, a user presses an actuator button 1162 (FIG. 13A) biased by an actuator button spring 1161, which is mounted to the hub 1100 overlying the abutment surfaces. The actuator button 1162 bears against inclined or arcuate distal contact surfaces of the latches 1160, retracting the latches from engagement with the abutment surfaces of the hub (FIG. 13D, 13G), and releasing the cross-arms 1034, 1036, 1038, 1040 to pivot and allow the frame to move towards its folded configuration (FIG. 13E).

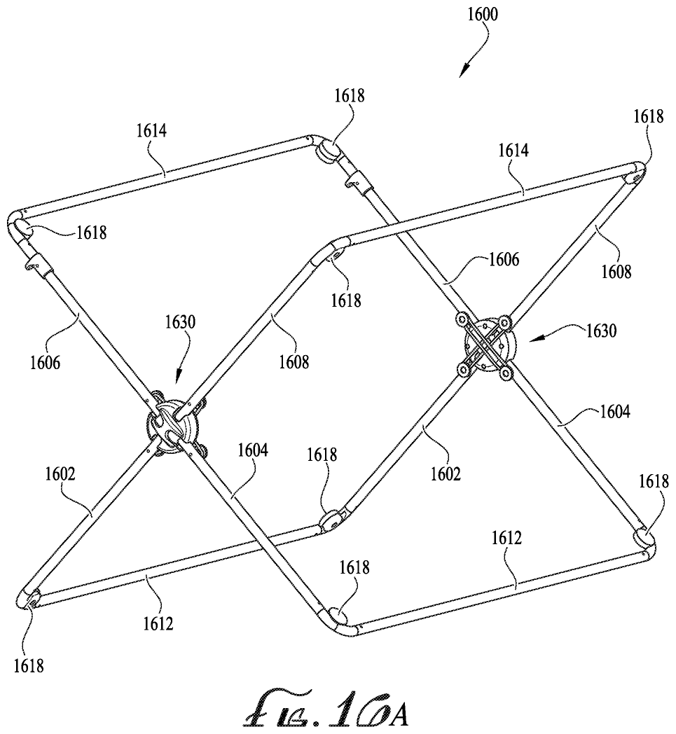

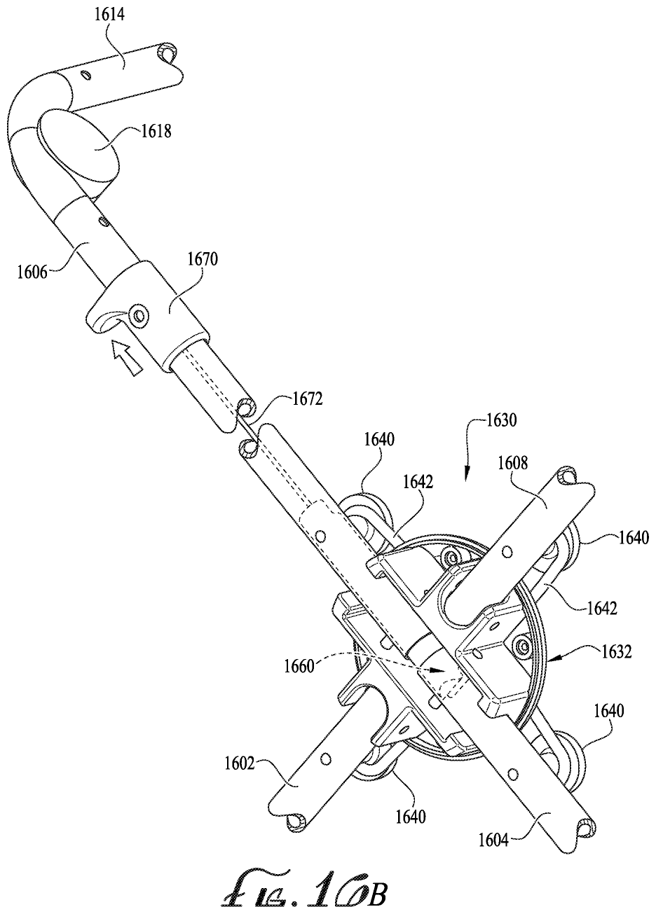

FIGS. 14A-14D show a play-yard 1400 according to another example embodiment. In similar fashion to the above-described embodiments, the play-yard 14 includes an outer soft-goods covering 1410 of fabric, mesh and/or other flexible material forming side and end walls, covering a folding frame 1420 comprising dynamic hinges 1430. The play-yard 1400 optionally includes accessories such as a removable bassinet 1460, a removable changing table 1462, a light 1464, and/or a media player or other electronic accessory 1466. The frame 1420 optionally includes floor-supporting extension rails 1422 extending along the lower side rails, for supporting a removable floor panel 1424, such as for example a foldable padded floor panel. FIGS. 14C and 14D show the frame 1420 of the play-yard 1400 in its fully expanded and fully folded configurations, respectively.

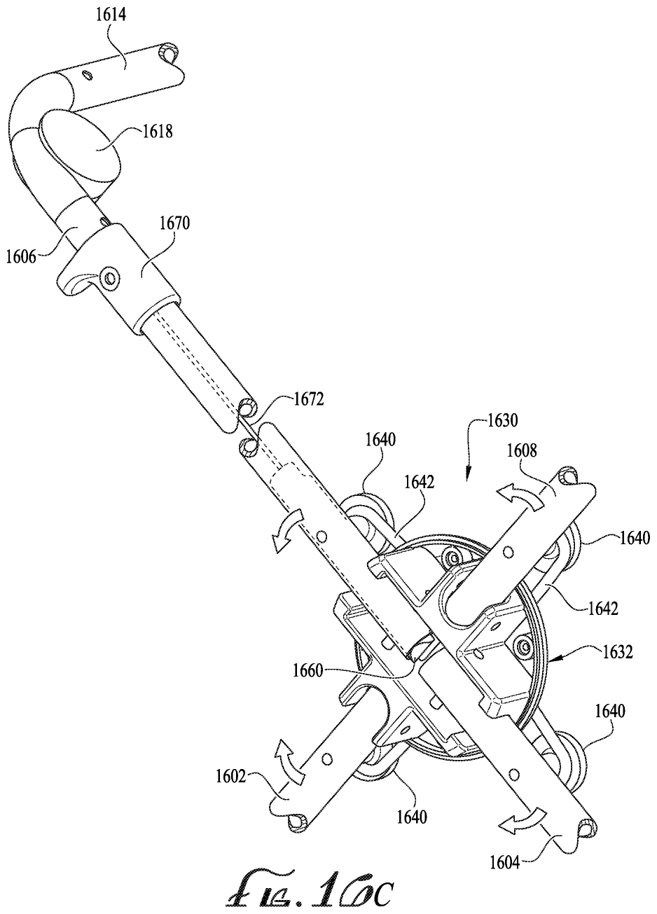

FIGS. 15A and 15B show a dynamic hinge 1500 according to another example embodiment. In similar fashion to the embodiment of FIG. 13, the dynamic hinge 1500 includes a hub 1510 pivotally coupling four cross-arms 1530, 1532, 1534, 1536 in a crosswise configuration oriented about 90° from one another and generally coplanar in theirs expanded positions as shown. Retainer collars 1540 on the cross-arms 1530, 1532, 1534, 1536 hold elastic bands or loops 1550 in tension, which bias the dynamic hinge to pivot the cross-arms outwardly toward the hinge's expanded or extended configuration. FIG. 15B shows the dynamic hinge 1500 with an outer housing portion of the hub 1510 removed to show internal components. The inner ends of two opposed cross-arms 1530, 1534 are fitted with interengaging gear wheels 1570, 1572, which links the pivotal motion of the cross-arms to one another. An internal damping mechanism is optionally provided, to control the speed at which the dynamic hinge 1500 expands under the bias of the elastic members 1550 when an apparatus incorporating the hinge is opened. In this manner, a smoother and more controlled operation may be provided.

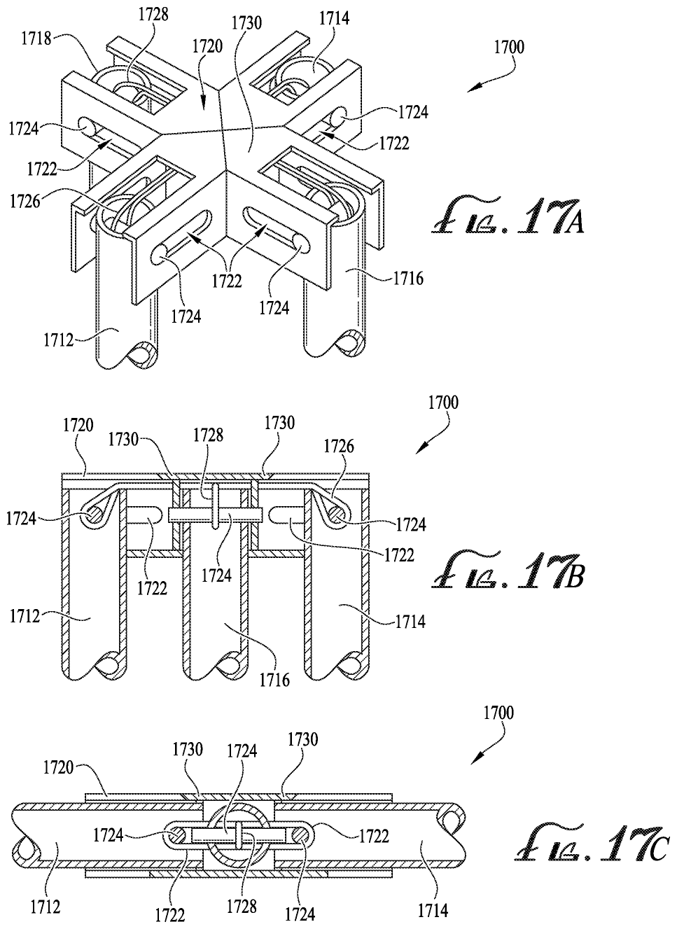

FIGS. 16A-16C show a structural support frame 1600 with dynamic hinges 1630 having a locking and release mechanism according to another example embodiment. Similar to previously described embodiments, the frame 1600 comprises first and second end wall support portions each comprising four cross-arms 1602, 1604, 1606, 1608 hingedly or pivotally coupled at their inner ends by the dynamic hinge 1630 arranged in a cross-wise or X-shaped array. The frame further comprises first and second sidewall support portions each comprising a lower frame siderail 1612 and an upper frame siderail 1614 hingedly or pivotally coupled by outer corner hinges 1618 between the outer ends of respective upper and lower cross-arms 1602, 1604, 1606, 1608. Also similar to previously described embodiments, the dynamic hinges 1630 each comprise a hub 1632 to which the cross-arms 1602, 1604, 1606, 1608 are hingedly or pivotally coupled, such as by pin joints or hinges, allowing the cross-arms to pivot in a first direction, outwardly relative to the hub (indicated by direction arrows in FIG. 16C); but preventing the cross-arms from pivoting in an opposite second direction, inwardly relative to the hub, beyond the fully extended or expanded position (FIGS. 16A, 16B) wherein the cross-arms are oriented substantially co-planar with one another and with the hub and spaced at about 90° from one another. Retainer collars 1640 are mounted to each of the cross-arms 1602, 1604, 1606, 1608 proximal their connections to the hub 1632, and elastic loops or bands 1642 are coupled in tension between retainer collars of opposed cross-arms in a cross-wise fashion, causing the dynamic hinges 1630 to bias the frame 1600 toward its expanded configuration (FIG. 16A), with the elastic tension and resultant biasing force increasing as the frame is folded.

The frame 1600 and dynamic hinge 1630 further comprise a locking and release mechanism that retains the frame in its expanded configuration once erected, until a user selectively releases the locking and release mechanism to allow the frame to be folded into its compact folded configuration. In example embodiments, two locking and release mechanisms are provided at spaced apart locations on the frame 1600, for example one on each endwall support portion, so that two separate releasing actuations are required, in order to reduce the likelihood of inadvertent folding of the frame while in use. In the example embodiment depicted, each locking and release mechanism comprises a spring biased latch 1660 or telescoping internal tube or rod portion translationally mounted within the inner end of one of the cross-arms 1606, which is biased to extend into engagement within the inner end of an opposed cross-arm 1604 when the frame is positioned in its expanded configuration. Engagement of the extended latch 1660 between the opposed cross-arms 1606, 1604 within the hub 1632 locks the hinge 1630 in its expanded configuration and prevents pivoting the cross-arms to fold the frame 1600. A release actuator 1670 is slidably mounted to the cross-arm 1606 and coupled to the latch 1660 by a cable or rod 1672. Operation of the actuator 1670 as indicated by the direction arrow in FIG. 16B overcomes the extension spring bias of the latch 1660, retracting the latch from engagement with cross-arm 1604, freeing the cross-arms to pivot and allowing the frame 1600 to be folded.

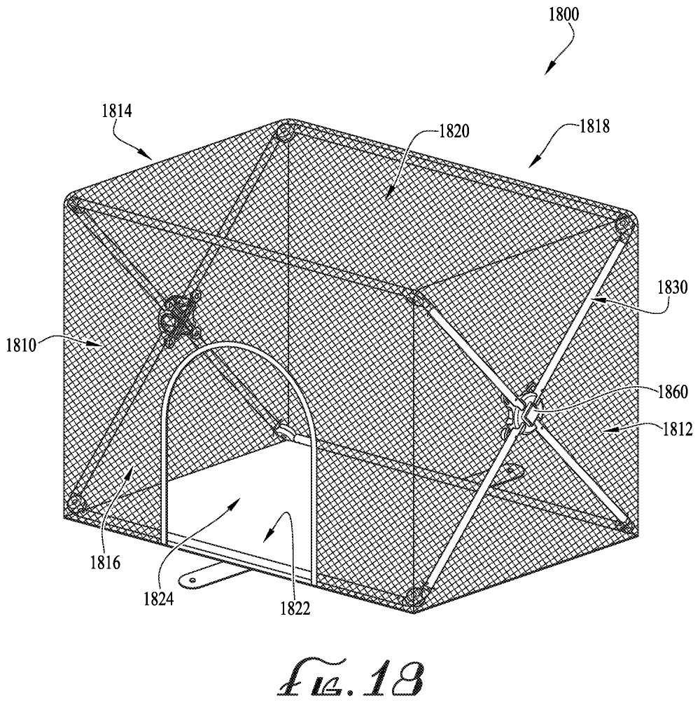

FIGS. 17A-17C depict another example embodiment of a dynamic hinge 1700. In this embodiment, the dynamic hinge 1700 is adapted for use with a structural frame constructed of hollow tubular frame components. The dynamic hinge 1700 comprises a first tubular frame portion 1712, a second tubular frame portion 1714, a third tubular frame portion 1716, and a fourth tubular frame portion 1718. The first tubular frame portion 1712 is coupled in line with the second tubular frame portion 1714 by a central hub 1720. Similarly, the third tubular frame portion 1716 is coupled in line with the fourth tubular frame portion 1718, both of which are also coupled to the central hub 1720. When in the expanded configuration, the first and second tubular frame portions 1712, 1714 are perpendicular to the third and fourth tubular frame portions 1716, 1718 such that the frame portions extend in an X-shape from the central hub 1720. The central hub 1720 comprises four receivers or sockets configured for slidably engaging inner ends of the tubular frame portions 1712, 1714, 1716, 1718 in a cross-wise configuration. Each of the receivers comprise a guide slot 1722 for slidingly receiving a guide post 1724 extending through the inner end of a corresponding one of the tubular frame portions 1712, 1714, 1716, 1718. A first elastic member 1726 is coupled in elastic tension between the opposed guide posts 1724 of the first and second tubular frame portions 1712, 1714. Similarly, a second elastic member 1728 is coupled in elastic tension between the guide posts 1724 of the third and fourth tubular frame portions 1716, 1718. The guide slots 1722 comprise a first and a second end. When the guide post 1724 is pulled to the second end of its corresponding guide slot 1722 by the elastic members 1726, 1728, the frame member is locked into an expanded position (FIG. 17C) by a lock tab 1730 adjacent the receiver of the hub 1720. The first and second elastic members 1726, 1728 bias the tubular frame portions 1712, 1714, 1716, 1718 into an open or assembled expanded position (FIG. 17C). In example embodiments, a user may overcome the bias of either or both of the elastic members 1726, 1728 to release the tubular frame portions 1712, 1714, 1716, 1718 from the receiver of the hub, and fold the tubular frame portions (FIG. 17B).

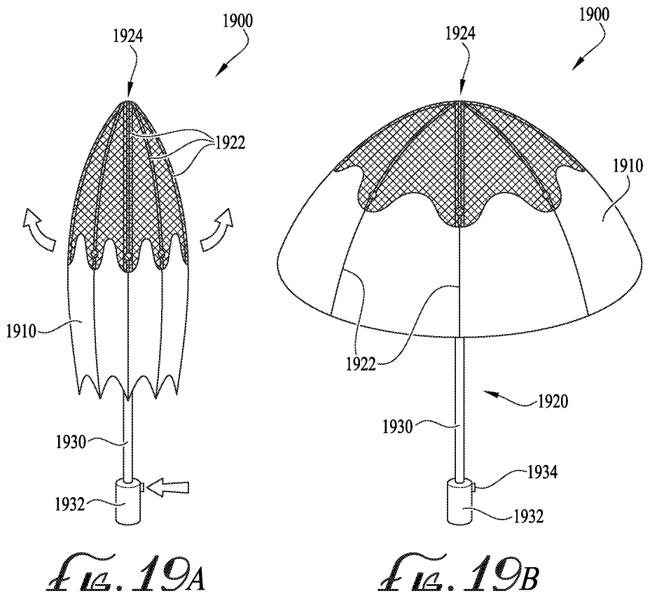

The dynamic hinge and folding frame assemblies disclosed may be utilized in connection with a variety of different structures, apparatus, processes and applications, including for example, and without limitation, children's accessories such as play-yards, bassinets, sleepers, rockers, toyboxes, etc.; tents, chairs, beds, tables, toys, kites, pet homes, tools, or any other piece of furniture, implement, containment device or equipment that may utilize a hinged folding frame assembly and/or an assisted or self-erecting structure. For example, FIG. 18 shows a collapsible pet home 1800, comprising a mesh or fabric soft goods cover 1810 applied over a folding frame 1830 comprising dynamic hinges 1860. In similar fashion to the above-described embodiments, the soft goods cover 1810 comprises first and second end walls 1812, 1814, front and back sidewalls 1816, 1818, a top or roof 1820, and optionally a floor 1822, bounding and defining an interior containment space for a dog, cat or other pet. An access door opening 1824 is provided in one of the endwalls or sidewalls, and a closable door is optionally provided for closing the door opening. Similar to above-described embodiments, the frame 1830 comprises endwall portions having cross-arms pivotally coupled in an X-shaped configuration at their inner ends to the dynamic hinges 1860, and upper and lower frame siderails hingedly coupled between outer ends of the cross-arms. The dynamic hinges 1860 comprise one or more elastic biasing members substantially as described above, biasing the frame toward its expanded configuration as depicted.

FIGS. 19A and 19B show another example embodiment of an apparatus in the form of an umbrella 1900 having a waterproof fabric rainfly or covering 1910 mounted to a collapsible or foldable support frame 1920. The support frame 1920 comprises a plurality of ribs 1922 pivotally coupled to a hub 1924, and a stalk 1930 having a handle or handgrip 1932. A dynamic hinge structure between the hub 1924 and the ribs 1922 according to any of the above-described embodiments is provided to bias the frame 1920 toward its expanded configuration (FIG. 19B). The frame optionally includes a locking and release mechanism for retaining the frame in its folded or compact configuration (FIG. 19A) against the bias of the dynamic hinge until released by a user upon actuation of an actuator button 1934 on the handle 1932.

While the invention has been described with reference to example embodiments, it will be understood by those skilled in the art that a variety of modifications, additions and deletions are within the scope of the invention, as defined by the following claims.

What is claimed is:

1. A children's play-yard apparatus comprising:
a support frame comprising a plurality of frame elements, at least a portion of the plurality of frame elements being pivotally coupled to one another to enable folding of the support frame from an expanded configuration to a folded configuration;
a flexible cover material supported by the support frame, the cover material configured to move with the support frame as it folds from the expanded configuration to the folded configuration; and
at least one dynamic hinge coupled between at least two of the plurality of frame elements, the dynamic hinge allowing pivotal movement between the at least two frame elements, and biasing the support frame from the folded configuration toward the expanded configuration.

2. The children's play-yard apparatus of claim 1, wherein the dynamic hinge comprises an elastic member engaged in tension between the at least two frame elements.

3. The children's play-yard apparatus of claim 2, wherein the elastic element comprises an elastic loop, and wherein the dynamic hinge further comprises a first retainer affixed to a first frame element of the at least two frame elements, and a second retainer affixed to a second frame element of the at least two frame elements, and wherein a first portion of the elastic loop extends around the first retainer and a second portion of the elastic loop extends around the second retainer.

4. The children's play-yard apparatus of claim 3, wherein the dynamic hinge further comprises a hub between the first retainer and the second retainer, and wherein the elastic element extends across the hub.

5. The children's play-yard apparatus of claim 1, wherein the dynamic hinge comprises a living hinge constructed of a resilient flexible material.

6. The children's play-yard apparatus of claim 5, wherein the dynamic hinge further comprises an elastic material extending across the living hinge.

7. The children's play-yard apparatus of claim 1, wherein a third frame element is coupled by a linkage to one of the at least two frame elements coupled by the dynamic hinge, whereby the third frame element moves between a first position and a second position under the influence of the pivotal movement between the at least two frame elements driven by the dynamic hinge.

8. The children's play-yard apparatus of claim 1, wherein the dynamic hinge comprises a replaceable tension cartridge engaged between the at least two frame elements.

9. The children's play-yard apparatus of claim 1, wherein the dynamic hinge further comprises a locking and release mechanism.

10. The children's play-yard apparatus of claim 1, wherein the at least two of the plurality of frame elements comprise four cross-arms arranged in a crosswise array, and wherein the dynamic hinge comprises a hub to which the four cross-arms are pivotally coupled.

11. The children's play-yard apparatus of claim 10, wherein each of the cross-arms comprises a retainer collar adjacent the hub, and wherein the dynamic hinge comprises first and second elastic members engaged in tension between the retainer collars in cross-wise fashion.

12. The children's play-yard apparatus of claim 1, further comprising a closure element for retaining the support frame in the folded configuration against the bias of the dynamic hinge.

13. A dynamic hinge assembly for pivotally coupling a first frame element and a second frame element of an apparatus, the dynamic hinge assembly comprising at least one elastic member having a first portion attached to the first frame element, a second portion attached to the second frame element, and an intermediate portion retained in tension between the first and second portions to bias the first and second frame elements from a first configuration to a different second configuration.

14. The dynamic hinge assembly of claim 13, wherein the apparatus is a children's play-yard apparatus.

15. The dynamic hinge assembly of claim 13, wherein the first frame element comprises a first retainer collar to which the first portion of the elastic member is attached, and wherein the second frame element comprises a second retainer collar to which the second portion of the elastic member is attached, and wherein the elastic member comprises an elastic loop.

16. The dynamic hinge assembly of claim 15, further comprising a hub portion between the first and second retainer collars, and wherein the elastic loop extends across the hub portion.

17. The dynamic hinge assembly of claim 13, wherein the elastic member comprises a replaceable tension cartridge engaged between the first frame element and the second frame element.

18. The dynamic hinge assembly of claim 13, further comprising a locking and release mechanism.

19. The dynamic hinge assembly of claim 13, comprising a hub to which the first frame element, the second frame element, a third frame element and a fourth frame element are pivotally coupled to form an X-shaped frame assembly, and wherein the at least one elastic member comprises a first elastic member coupled between an opposed first pair of frame members comprising the first and third frame members, and a second elastic member coupled between an opposed second pair of frame members comprising the second and fourth frame members.

20. A folding apparatus comprising:
a structural support frame comprising a first frame element, a second frame element, a third frame element, and a fourth frame element, the frame being reconfigurable between an expanded configuration and a compact configuration; and
a dynamic hinge pivotally coupling at least the first frame element and the second frame element, the dynamic hinge comprising at least one elastic element engaged in tension between the first frame element and the second frame element when the frame is in its compact configuration, whereby the elastic element at least partially assists in erecting the frame from the compact configuration to the expanded configuration.

21. The folding apparatus of claim 20, further comprising a soft goods cover attached to the structural support frame to define a contained space when the frame is in its expanded configuration.

22. The folding apparatus of claim 20, wherein the apparatus is selected from a children's play-yard, a bassinet, a pet home, and an umbrella.

23. The folding apparatus of claim 20, wherein the third frame element is coupled to the first frame element by a first linkage, and wherein the fourth frame element is coupled to the second frame element by a second linkage, and wherein the third and fourth frame elements move in response to motion of the first and second frame elements driven by the dynamic hinge.

24. The folding apparatus of claim 20, wherein the dynamic hinge comprises a hub to which the first frame element, the second frame element, the third frame element, and the fourth frame element are pivotally coupled in a cross-wise array, and wherein the at least one elastic element comprise a first elastic element engaged in tension between the first and second frame elements, and a second elastic element engaged in tension between the third and fourth frame elements.
